(19) United States
(12) Patent Application Publication
(10) Pub. No.: US 2019/0090502 A1
(43) Pub. Date: Mar. 28, 2019

(54) WHOLE-BEAN SOYMILK HAVING INCREASED BIOAVAILABILITY OF SOY ISOFLAVONES AND METHOD OF PREPARING THE SAME

(71) Applicant: AGV PRODUCTS CORP., Minsyong Township (TW)

(72) Inventors: Kwan-Han CHEN, Minsyong Township (TW); Hung-Chi HSIAO, Minsyong Township (TW); Hui-Min LAI, Minsyong Township (TW); Chien-Yu CHEN, Minsyong Township (TW); Chia-Ching LI, Minsyong Township (TW); Yi-Shian WANG, Minsyong Township (TW); Ming-Chi TSAI, Minsyong Township (TW)

(21) Appl. No.: 16/127,386

(22) Filed: Sep. 11, 2018

(30) Foreign Application Priority Data
Sep. 26, 2017 (TW) 106132895

(51) Int. Cl. A23C 11/10; A23L 11/30

(52) U.S. Cl. CPC A23C 11/103; A23L 11/33; A23V 2002/00; C12Y 302/01021; A23V 2300/38; A23V 2300/31; A23V 2250/21

(57) ABSTRACT

Disclosed herein is a whole-bean soymilk having an increased level of deglycosylated soy isoflavones and a method of preparing thereof. The method includes the steps of subjecting a mixture of a soybean material and water to a comminution treatment so as to obtain a soybean slurry, subjecting the soybean slurry to an enzymatic hydrolysis treatment using a β-glucosidase to obtain a hydrolysate, and subjecting the hydrolysate to a media milling treatment using a milling medium.

### CROSS-REFERENCE TO RELATED APPLICATION

This application claims priority of Taiwanese Patent Application No. 106132895, filed on Sep. 26, 2017.

### FIELD

The disclosure relates to whole-bean soymilk having an increased level of deglycosylated soy isoflavones and a method of preparing the same.

### BACKGROUND

Soymilk is a soybean product that is rich in high-quality proteins and free of lactose. Therefore, soymilk is a good source of dietary proteins for general consumers, and is also a suitable substitute for dairy products with respect to lactose-intolerant populations.

In addition, soymilk contains many biologically active phytochemicals, such as soy isoflavones, polyphenols, phytate, saponins, lecithin, phytosteroids and tocopherol. Previous studies reported that soy isoflavones have antioxidant activity, and are effective in preventing cardiovascular diseases, type 2 diabetes mellitus, cancer and osteoporosis, as well as in alleviating menopausal syndrome, etc.

Soy isoflavones can be classified into the following two types depending on the presence or absence of glucoside: (1) glycosylated soy isoflavones (also referred to as soy isoflavone glycosides) that include daidzin, genistin, glycitin, malonyldaidzin, malonylgenistin, malonylglycitin, acetyldaidzin and acetylglycitin; and (2) deglycosylated soy isoflavones (also referred to as soy isoflavone aglycones) that include daidzein, genistein and glycitein. Deglycosylated soy isoflavones have higher bioavailability as compared to glycosylated soy isoflavones, and thus may achieve better health benefits. Therefore, it is becoming important to prepare a soybean product with a high content of deglycosylated soy isoflavones.

Traditional soymilk (also known as filtered soymilk) is prepared by pulverizing a soybean material soaked in water, subsequently filtering the resulting soybean slurry with gauze, and optionally heating the thus obtained filtrate for sterilization. Although the filtration treatment can remove soybean dregs having a large particle size from the soybean slurry and enhance the taste of the resultant filtered soymilk, such treatment also reduces the amount of nutrients and active ingredients of the soybean slurry, thereby reducing the nutritional value of the filtered soymilk. In order to solve this problem, those skilled in the art have endeavored to prepare soymilk without using the filtration treatment or other separation processes. Although the soymilk thus prepared (also known as whole-bean soymilk) would retain a larger amount of nutrients and active ingredients, the whole-bean soymilk can hardly achieve a desired taste. Therefore, researchers in this field have been trying to prepare whole-bean soymilk with a reduced particle size and also a high level of active ingredients (e.g., deglycosylated soy isoflavones).

It has been reported that a media milling treatment may not only improve the stability of whole-bean soymilk by reducing the average particle size and increasing the viscosity, but also increase the amount of the soy isoflavones and deglycosylated soy isoflavones in the whole-bean soymilk. For example, as described in Kuo H. Y. et al. (2014), J. Agric. Food Chem., 62:742-749, a high-speed blender and a media mill loaded with yttria-stabilized zirconia beads having an average particle size of 0.8 mm (such beads served as a milling medium) were respectively used to grind a soybean slurry in order to prepare two different kinds of whole-bean soymilk (i.e., blended soymilk and media-milled soymilk). By comparing the differences in the physical properties and the contents of active ingredients regarding these two types of whole-bean soymilk and traditional filtered soymilk, it was found that the media-milled soymilk has an average particle size significantly lower than that of the blended soymilk, and similar to that of the traditional filtered soymilk. In addition, the media-milled soymilk had been found to have higher viscosity and stability, as well as a higher amount of soy isoflavones and deglycosylated soy isoflavones. Therefore, Kuo H. Y. et al. deduced that the stability of the media-milled soymilk is due to its small average particle size and high viscosity.

On the other hand, it is noted that deglycosylation of glycosylated soy isoflavones via an enzymatic hydrolysis treatment can effectively increase the amount of deglycosylated soy isoflavones in a soybean product. For example, U.S. Pat. No. 6,444,239 B2 discloses an isoflavone aglycone-containing composition which is prepared by subjecting an extract (e.g., soymilk) of a soy protein raw material to an enzymatic hydrolysis treatment using a protease and β-glucosidase.

Taiwanese Invention Patent No. 1290176 discloses a method for increasing the content of deglycosylated soy isoflavones in soy yogurt with β-glucanase. The method mainly includes: homogenizing a soybean slurry obtained via grinding to increase the release rate of soy isoflavones from grinded solids of the soybean slurry (also known as homogenization refining treatment), and then subjecting the resultant homogenized product to hydrolysis reaction with β-glucanase (i.e., converting glycosylated soy isoflavones to deglycosylated soy isoflavones) and to fermentation with lactic acid bacteria. From the teaching of this Taiwanese Patent, it is noted that refinement of a soybean material to increase the reaction area for a subsequent enzymatic hydrolysis treatment is a desired technical means in this field to improve the effectiveness of the enzymatic hydrolysis treatment.

### SUMMARY

Therefore, an object of the present disclosure is to provide whole-bean soymilk having an increased level of deglycosylated soy isoflavones and a method of preparing the same, both of which can alleviate at least one of the drawbacks associated with the prior art.

According to one aspect of the disclosure, a method for preparing whole-bean soymilk having an increased level of deglycosylated soy isoflavones includes the steps of:

subjecting a mixture of a soybean material and water to a comminution treatment, so as to obtain a soybean slurry;

subjecting the soybean slurry to an enzymatic hydrolysis treatment using β-glucosidase to obtain a hydrolysate; and

subjecting the hydrolysate to a media milling treatment using a milling medium.

According to another aspect of the disclosure, whole-bean soymilk obtained using a method as mentioned above is provided.

According to yet another aspect of the disclosure, a food product including whole-bean soymilk as mentioned above is provided.

### BRIEF DESCRIPTION OF THE DRAWINGS

Other features and advantages of the present disclosure will become apparent in the following detailed description of the embodiment with reference to the accompanying drawing, of which:

FIG. 1 is a flow chart illustrating consecutive steps of preparing whole-bean soymilk of the present disclosure.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it should be clearly understood that the word “comprising” means “including but not limited to”, and that the word “comprise” has a corresponding meaning.

Unless otherwise defined, all technical and scientific terms used herein have the meaning as commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

In order to reduce nutrient loss and increase active ingredient contents of whole-bean soymilk, and to improve the taste thereof, the applicants found by research that, by subjecting a soybean slurry to an enzymatic hydrolysis treatment with β-glucosidase, and subsequently to a media milling treatment, the thus obtained whole-bean soymilk of this disclosure has not only a smaller particle size and a higher viscosity, but also an increased level of deglycosylated soy isoflavones and even substantially none of glycosylated soy isoflavones, as compared to the whole-bean soymilk prepared by either one of the enzymatic hydrolysis treatment or the media milling treatment, or by reversing the order of the above-mentioned two treatments.

Therefore, the present disclosure provides a method of preparing whole-bean soymilk having an increased level of deglycosylated soy isoflavones, which includes the steps of subjecting a mixture of a soybean material and water to a comminution treatment so as to obtain a soybean slurry, subjecting the soybean slurry to an enzymatic hydrolysis treatment using β-glucosidase to obtain a hydrolysate, and subjecting the hydrolysate to a media milling treatment using a milling medium.

Examples of the soybean material suitable for this disclosure may include, but are not limited to, soy granules, soy flakes, soy grits, soy flour, and combinations thereof. In an exemplary embodiment, the soybean material is soy granules.

As used herein, the term “whole-bean soymilk” means soymilk prepared in a manner, in which all the nutrients in an intact or peeled soy material are retained under the condition that, there is no loss or depletion in any available portion of the soybean material, or soybean refuse is not generated, during the preparation.

According to this disclosure, the whole-bean soymilk has an average particle size ranging from 10 μm to 61 μm. In an exemplary embodiment, the average particle size of the whole-bean soymilk ranges from 40 μm to 50 μm (e.g., 44.04 μm).

According to this disclosure, the whole-bean soymilk is substantially free of glycosylated soy isoflavone.

As used herein, the term “substantially free of” means the lack of meaningful content of a specifically identified ingredient. In certain embodiments, the content (for example, 0.2 mg/g or less) of the ingredient has no measureable effect on the properties of the whole-bean soymilk. Preferably, the whole-bean soymilk is completely free of the specified ingredient.

As used herein, the term “comminute” and any other word forms or cognates thereof, such as, without limitation, “comminution” and “comminuting”, includes the process of breaking a soybean material into a soybean slurry having a smaller particle size by any suitable method, including, but is not limited to, grinding, hammering, crushing, pulverizing and/or blending. In an exemplary embodiment, the soybean slurry obtained by the comminution treatment has an average particle size ranging from 100 μm to 1000 μm.

According to this disclosure, the enzymatic hydrolysis treatment using β-glucosidase may be carried out using techniques well-known and customary to those skilled in the art.

It is understood that, conditions for carrying out the enzymatic hydrolysis treatment may vary depending on factors, such as the applied ratio of the soybean slurry to β-glucosidase, reaction temperature and reaction time, in order to achieve a desired enzymatic hydrolysis effect. The choice of the conditions for the enzymatic hydrolysis treatment may be routinely determined by those skilled in the art.

In certain embodiments, the amount of β-glucosidase used in the enzymatic hydrolysis treatment ranges from 0.05% (w/w) to 0.2% (w/w). In an exemplary embodiment, the amount of β-glucosidase used in the enzymatic hydrolysis treatment is 0.1% (w/w).

In certain embodiments, the enzymatic hydrolysis treatment is conducted at a temperature ranging from 35° C. to 50° C. In an exemplary embodiment, the enzymatic hydrolysis treatment is conducted at 40° C.

In certain embodiments, the enzymatic hydrolysis treatment is conducted for a time period ranging from 15 minutes to 90 minutes. In an exemplary embodiment, the enzymatic hydrolysis treatment is conducted for 30 minutes.

As used herein, the terms “media milling”, “sand milling” and “bead milling” can be used interchangeably, and mean that a material to be milled flows from one end of a container loaded with a milling medium along a direction [including a vertical direction (for example, from a bottom end to a top end) and a horizontal direction] to another end of the container, and at the same time, the milling medium driven by an agitator generates collision force and shear stress in a high energy density to reduce the average particle size of solid particles contained in the material to be milled.

According to this disclosure, the milling medium has sufficiently satisfactory physical and chemical properties (such as physical strength and chemical stability) so as to avoid physical degradation or chemical interaction during the media milling treatment.

Examples of the milling medium suitable for this disclosure may include, but are not limited to, glass beads, silicon carbide beads, zircon beads, zirconia beads, yttria-stabilized zirconia beads, stainless steel beads, ceramic beads and combinations thereof. In an exemplary embodiment, the milling medium is yttria-stabilized zirconia beads.

In certain embodiments, the milling medium has an average particle size ranging from 0.03 mm to 2.0 mm. In an exemplary embodiment, the average particle size of the milling medium is 0.8 mm.

In certain embodiments, the media milling treatment is conducted at an agitation speed ranging from 2500 rpm to 3200 rpm. In an exemplary embodiment, the agitation speed of the media milling treatment is 3000 rpm.

According to this disclosure, the method further includes heating the hydrolysate prior to the media milling treatment so as to inactivate β-glucosidase. In certain embodiments, the hydrolysate is heated at a temperature ranging from 85° C. to 100° C. In an exemplary embodiment, the hydrolysate is heated at 95° C.

The present disclosure also provides whole-bean soymilk having an increased level of deglycosylated soy isoflavones as obtained from the method described above.

According to this disclosure, the whole-bean soymilk may be in the form of a food additive, which can be added during preparation of raw materials using a conventional method, or can be added, during food production, into any edible material to prepare a food product for human and non-human animal consumption.

Accordingly, this disclosure also provides a food product including the whole-bean soymilk as described above.

Examples of the food product suitable for this disclosure may include, but are not limited to, milk powder, beverages, confectionery, ice-cream, cookies, spreads, seasoning, fermented foods, animal feeds, health foods and dietary supplements.

This disclosure will be further described by way of the following examples. However, it should be understood that the following examples are solely intended for the purpose of illustration and should not be construed as limiting the disclosure in practice.

### EXAMPLES

### Example 1. Preparation of Whole-Bean Soymilk

### Experimental Procedures:

First, 300 g of soy granules (purchased from Kaohsiung District Agricultural Improvement Station, Taiwan) were soaked in 2700 g of water at 4° C. overnight. The resulting mixture was subjected to a comminution treatment for 3 minutes using a laboratory blender (Manufacturer: Waring® Laboratory Science; Model: MX-7012S), so as to obtain a soybean slurry. Thereafter, the thus obtained soybean slurry was divided into an experimental group and 5 control groups (i.e., control groups 1 to 5), each of which was subjected to a processing treatment as shown in Table 1 below.

TABLE 1

| Group | Processing treatment | Type of soymilk |
|---|---|---|
| Experimental | An enzymatic hydrolysis treatment | Whole-bean |
| group | followed by a media milling treatment | soymilk |
| Control | A media milling treatment followed | |
| group 1 | by an enzymatic hydrolysis treatment | |
| Control | An enzymatic hydrolysis treatment | |
| group 2 | followed by a homogenization refining | |
| | treatment | |
| Control | A media milling treatment | |
| group 3 | | |
| Control | An enzymatic hydrolysis treatment | |
| group 4 | | |
| Control | A filtering treatment (for removing | Filtered |
| group 5 | soybean dregs) | soymilk |

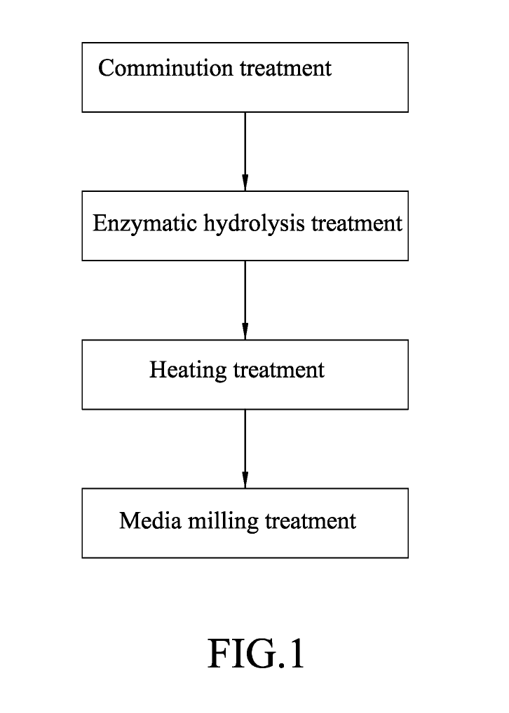

To be specific, the processing treatment of the experimental group was carried out according to the procedures as described below. First, the soybean slurry was added with 0.1% (w/w, g/g) of β-glucosidase (purchased from Sternzym) to conduct an enzymatic hydrolysis treatment at 40° C. for 30 minutes. The thus obtained hydrolysate was heated at 95° C. for 10 minutes to inactivate the β-glucosidase. Subsequently, by virtue of a nano media mill (Manufacturer: Netzsch Feinmahltechnik GmbH; Model: MiniPur) loaded with yttria-stabilized zirconia beads (Manufacturer: Netzsch Feinmahltechnik GmbH; purchased from Jienan Enterprise Co. Ltd., Taiwan) having a particle size of 0.8 mm and serving as a milling medium, the hydrolysate was subjected to a media milling treatment at 16° C. with an agitation speed of 3000 rpm for 15 minutes, so as to obtain whole-bean soymilk. For the sake of clarity, the preparation process of the whole-bean soymilk of the experimental group is shown in FIG. 1.

The processing treatment of the control group 1 was carried out according to the procedures similar to those of the experimental group, except that the soybean slurry was first subjected to the media milling treatment and then subjected to the enzymatic hydrolysis treatment.

The processing treatment of the control group 2 was carried out according to the procedures similar to those of the experimental group, except that the media milling treatment was replaced with a homogenization refining treatment in accordance with Taiwanese Invention Patent No. 1290176. Briefly, the homogenization refining treatment was performed using a homogenizer (Manufacturer: YuhShing Co. Ltd., Taiwan; Model: YS-300) at a pressure of 100 kg/cm².

The processing treatment of the control group 3 was carried out according to the procedures similar to those of the experimental group, except that the soybean slurry was directly subjected to the media milling treatment without the enzymatic hydrolysis treatment.

The processing treatment of the control group 4 was carried out according to the procedures similar to those of the experimental group, except that the media milling treatment was not conducted.

As to the control group 5, the soybean slurry was subjected to a filtering treatment using a double layered cheesecloth to remove soybean dregs, so as to obtain filtered soymilk.

The whole-bean soymilk of the experimental group and control groups 1 to 4 and the filtered soymilk of the control group 5 were sterilized at 95° C. for 10 minutes for further analysis.

### Example 2. Measurement of Average Particle Size, Solid Matter Content and Insoluble Dietary Fiber Content for Whole-Bean Soymilk

To determine the difference of the soymilk of all the groups prepared in Example 1 with respect to the average particle size, solid matter content and insoluble dietary fiber content, the following experiments were conducted.

### Experimental Procedures:

### A. Determination of Average Particle Size

The average particle size of the soymilk of each group was measured using a compact laser diffraction particle size analyzer (Manufacturer: Horiba; Model: LA-300).

### B. Determination of Solid Matter Content

The water content of the soymilk of each group was measured in accordance with a standardized method, CNS 5033 N6114 of the Chinese National Standards (CNS), Taiwan. The solid matter content of the soymilk was then calculated based on the measured water content.

### C. Determination of Insoluble Dietary Fiber Content

The insoluble dietary fiber content of the soymilk of each group was measured in accordance with a standardized method, AOAC 991.42 of the Association of Official Agricultural Chemists (AOAC), USA.

### Results:

The measurement results of each group are shown in Table 2.

TABLE 2

| | Average | Solid | Insoluble |
|---|---|---|---|
| | particle | matter | dietary fiber |
| Group | size (μm) | content (%) | content (mg/g) |
| Experimental group | 44.04 | 8.5 | 209.17 |
| Control group 1 | 65.87 | 8.5 | 206.37 |
| Control group 2 | 197.10 | 9.4 | 221.28 |
| Control group 3 | 61.63 | 8.3 | 206.02 |
| Control group 4 | 186.95 | 9.0 | 224.20 |
| Control group 5 | 2.79 | 7.5 | 62.31 |

As shown in Table 2, although the average particle size of the filtered soymilk of the control group 5 was significantly lower than that of the respective one of the whole-bean soymilk of the experimental group and the control groups 1 to 4, the solid matter content and the insoluble dietary fiber content of the control group 5 were respectively significantly lower than those of the remaining groups. This result reveals that a large amount of insoluble dietary fiber present in soybean dregs that is produced by a comminution treatment would be removed by filtration, thereby reducing the nutritional value of filtered soymilk.

On the other hand, there was no significant difference in the solid matter content and the insoluble dietary fiber content between the experimental group and control groups 1 to 4. Regarding the average particle size, no significant difference was observed between the control group 1 and the control group 3, while a significant decrease was seen for the experimental group. This result indicates that performing an enzymatic hydrolysis treatment after a media milling treatment substantially has no negative effect on the average particle size of whole-bean soymilk. However, by reversing the order of performing an enzymatic hydrolysis treatment and a media milling treatment (that is, subjecting a soybean slurry to an enzymatic hydrolysis treatment first and then a media milling treatment), the average particle size of whole-bean soymilk can be effectively reduced. Moreover, the whole-bean soymilk of the experimental group had a significantly smaller average particle size than those of the control groups 2 and 4, indicating that performing a media milling treatment after an enzymatic hydrolysis treatment is substantially better in terms of reducing the average particle size of whole-bean soymilk, as compared to performing an enzymatic hydrolysis treatment only or further performing a homogenization refining treatment thereafter. Therefore, the whole-bean soymilk of the experimental group is considered to have superior flavor, taste and stability.

### Example 3. Measurement of Soy Isoflavone Content of Whole-Bean Soymilk

To compare the difference in soy isoflavone content between the soymilk of all the groups prepared in Example 1, the following experiment was conducted.

### Experimental Procedures:

The soymilk of each group was freeze-dried to obtain lyophilized powder serving as a test sample. The test sample of each group was subjected to isoflavone extraction and high performance liquid chromatography (HPLC) analysis according to the method described in Wei Q. K. et al. (2004), J. Food Drug Anal., 12:324-331, followed by calculation of the soy isoflavone content (mg/g) in each test sample.

For comparison, the following six soy isoflavones (in a serial concentration of 0.5 to 40 μg/mL) (purchased from Sigma-Aldrich Corporation), including three glycosylated soy isoflavones (i.e., daidzin, genistin and glycitin) and three deglycosylated soy isoflavones (i.e., daidzein, genistein and glycitein), were used as control standards and subjected to the same HPLC analysis as mentioned above.

### Results:

The soy isoflavone content in the soymilk of each group thus determined is shown in Table 3.

TABLE 3

| | | | | Percentage of |
|---|---|---|---|---|
| | Glycosyl- | Deglycosyl- | | deglycosylated |
| | ated soy | ated soy | Total soy | soy isoflavone |
| | isoflavone | isoflavone | isoflavone | with respect |
| | content^{a} | content^{b} | content^{c} | to total soy |
| Group | (mg/g) | (mg/g) | (mg/g) | isoflavone^{d} (%) |
| Experimental | 0.00 | 1.66 | 1.66 | 100 |
| group | | | | |
| Control group 1 | 0.15 | 1.41 | 1.56 | 90.2 |
| Control group 2 | 0.20 | 1.19 | 1.39 | 85.6 |
| Control group 3 | 1.30 | 0.30 | 1.60 | 18.8 |
| Control group 4 | 0.54 | 0.96 | 1.50 | 64.0 |
| Control group 5 | 1.13 | 0.09 | 1.22 | 7.3 |

^{a}The content of glycosylated soy isoflavone was calculated by adding up the measured contents of daidzin, genistin and glycitin.
^{b}The content of deglycosylated soy isoflavone was calculated by adding up the measured contents of daidzein, genistein and glycitein.
^{c}The total content of soy isoflavone was calculated by adding up the contents of glycosylated soy isoflavone and deglycosylated soy isoflavone.
^{d}The percentage of deglycosylated soy isoflavone with respect to total soy isoflavone was calculated by dividing the content of deglycosylated soy isoflavone by the total content of soy isoflavone.

As shown in Table 3, the percentage of deglycosylated soy isoflavone with respect to the total soy isoflavone in the experimental group was higher than that of each of the control groups 1 to 5. This result reveals that in the process of preparing whole-bean soymilk, when soybean is sequentially subjected to an enzymatic hydrolysis treatment and a media milling treatment, glycosylated soy isoflavones can be effectively deglycosylated to form deglycosylated soy isoflavones with higher bioavailability, thereby rendering the whole-bean soymilk of this disclosure more bioavailable (i.e., the whole-bean soymilk of this disclosure has an increased level of deglycosylated soy isoflavones).

All patents and literature references cited in the present specification as well as the references described therein, are hereby incorporated by reference in their entirety. In case of conflict, the present description, including definitions, will prevail.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for preparing whole-bean soymilk having an increased level of deglycosylated soy isoflavones, comprising the steps of:
subjecting a mixture of a soybean material and water to a comminution treatment, so as to obtain a soybean slurry;
subjecting the soybean slurry to an enzymatic hydrolysis treatment using β-glucosidase to obtain a hydrolysate; and
subjecting the hydrolysate to a media milling treatment using a milling medium.

2. The method as claimed in claim 1, wherein the whole-bean soymilk has an average particle size ranging from 10 μm to 61 μm.

3. The method as claimed in claim 1, wherein the whole-bean soymilk is substantially free of glycosylated soy isoflavones.

4. The method as claimed in claim 1, wherein the media milling treatment is conducted at an agitation speed ranging from 2500 rpm to 3200 rpm.

5. The method as claimed in claim 1, wherein the milling medium is selected from the group consisting of glass beads, silicon carbide beads, zircon beads, zirconia beads, yttria-stabilized zirconia beads, stainless steel beads, ceramic beads and combinations thereof.

6. The method as claimed in claim 1, wherein an amount of β-glucosidase used in the enzymatic hydrolysis treatment ranges from 0.05% (w/w) to 0.2% (w/w).

7. The method as claimed in claim 1, wherein the enzymatic hydrolysis treatment is conducted at a temperature ranging from 35° C. to 50° C.

8. The method as claimed in claim 1, further comprising heating the hydrolysate prior to the media milling treatment so as to inactivate β-glucosidase.

9. The method as claimed in claim 1, wherein the soybean slurry has an average particle size ranging from 100 μm to 1000 μm.

10. Whole-bean soymilk obtained from a method as claimed in claim 1.

11. The whole-bean soymilk as claimed in claim 10, which has an average particle size ranging from 10 μm to 61 μm.

12. The whole-bean soymilk as claimed in claim 10, which is substantially free of glycosylated soy isoflavones.

13. A food product comprising whole-bean soymilk as claimed in claim 10.
